(19) United States
(12) Patent Application Publication
(10) Pub. No.: US 2009/0029281 A1
(43) Pub. Date: Jan. 29, 2009

(54) TWO-COMPONENT DEVELOPER AND IMAGE FORMING DEVICE

(75) Inventor: Seiji Kikushima, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/164,151

(22) Filed: Jun. 30, 2008

(30) Foreign Application Priority Data
Jul. 25, 2007 (JP) 2007-193399

(51) Int. Cl. G03G 9/083; G03G 9/08; G03G 15/09

(52) U.S. Cl. 430/111.3; 430/111.1; 399/270

(57) ABSTRACT

To provide a two-component developer and an image forming device which are excellent in stability of image density in formed images even when image formation is continued for a long time, by controlling non-electrostatic adhesion force between toner particle and a carrier or developing roll and maintaining the charge property of toner particle effectively. A two-component developer in which the surface of a toner particle and the surface of a carrier are each covered with a fluorine compound, wherein a ratio represented by (A2/A1) is adjusted to a value within a range of from 0.1 to 0.5 where the coverage with the fluorine compound on the surface of the toner particle is A1 and the coverage with the fluorine compound on the surface of the carrier is (A2).

### BACKGROUND OF THE INVENTION

1. Field of the Invention

The present invention relates to two-component developers and image forming devices. In particular, it relates to two-component developers which are excellent in image density stability in formed images when image formation is conducted for a long time, and to image forming devices.

2. Description of the Related Art

Conventionally, in electrophotographic systems, the two-component development system using a two-component developer composed of toner particle and a carrier is adopted widely.

In the two-component development system, toner particle are charged via a carrier. Therefore, the system is advantageous, over the one-component development system using no carriers, in that it is superior in the charging property of a developer and better in the uniformity of solid images, and that it can serve for elongation of life of developing devices.

However, due to a high environment dependency, the two-component development system has a problem that the image density in formed images tends to be unstable particularly under high temperature, high humidity environment.

It is likely that the cause of this problem is that the non-electrostatic adhesion force between toner particle and a carrier or a developing roll increases or the charging property of the toner particle deteriorates with changes of the environment and, as a result, the quantity of development to a latent image support becomes unstable.

In order to obtain a stable image density regardless of environmental change, a two-component developer is proposed which is obtained by mixing carrier particles each having a fluororesin-containing resin coating layer (fluorocarbon resin coating layer) with toner particle so that the fluororesin is transferred to the surfaces of the toner particle at a surface fluorine concentration of 4 to 8 atm % (e.g., patent document 1 JP-A 8-328295 Claims).

When using the two-component developer of patent document 1, it was able to control the environment dependency in image density by stably controlling the non-electrostatic adhesion force between toner particle and a carrier or a developing roll and the charging property of the toner particle surely in the initial stage of image formation.

However, in the two-component developer of patent document 1, the fluororesin on the toner particle surface has only been transferred due to its collision with a carrier. Therefore, when a long-time image formation (e.g., 50,000-sheet intermittent printing) was performed, there was a problem that the coverage ratio with the fluororesin on the toner particle surface varies and it is difficult to obtain a stable image density.

In the use of the two-component developer of patent documents 1 in the touchdown development system, there was a problem that the aforementioned problem becomes more apparent.

In the touchdown development system, a monocomponent developer layer is formed on a developing roll from a two-component developer layer (magnetic brush) on a magnetic roll, and a developed layer is formed on the latent image on an electrostatic latent image support. If the non-electrostatic adhesion force between toner particle and a carrier or a developing roll or the charging property of the toner particle becomes unstable, the thickness of the monocomponent developer layer on the developing roll becomes unstable and, as a result, it becomes more difficult to obtain a stable image density.

Then, as a result of earnest investigations, the inventors of the present invention have found that by covering the surface of a toner particle with a fluorine compound (a fluorine-containing compound) and covering the surface of a carrier with a fluorine compound (a fluorine-containing compound) and adjusting the ratio of the coverage (A1) of the toner surface and the coverage (A2) of the carrier surface to within a predetermined range, it is possible to control the non-electrostatic adhesion force between toner particle and a carrier or a developing roll and to maintain the charging characteristics of the toner particle effectively. Thereby, they have accomplished the present invention.

### SUMMARY OF THE INVENTION

That is, an object of the invention is to provide a two-component developer and an image forming device which are excellent in stability of image density in formed images even when image formation is continued for a long time, by controlling non-electrostatic adhesion force between toner particle and a carrier or developing roll and maintaining the charging property of toner particle effectively.

According to the present invention, a two-component developer is provided in which the surface of a toner particle and the surface of a carrier are each covered with a fluorine compound, wherein a ratio represented by A2/A1 (which may, henceforth, be called “coverage ratio”) is adjusted to a value within a range of from 0.1 to 0.5 where A1 is a coverage with the fluorine compound on the surface of the toner particle and A2 is a coverage with the fluorine compound on the surface of the carrier. Thereby, the aforementioned problems can be solved.

That is, by covering the surface of a toner particle with a fluorine compound and covering the surface of a carrier with a fluorine compound and adjusting the ratio of the coverage (A1) of the toner surface and the coverage (A2) of the carrier surface to within a predetermined range, it is possible to control the non-electrostatic adhesion force between toner particle and a carrier or a developing roll and to maintain the charging property of the toner particle effectively.

Moreover, because the fluorine compound on the toner particle surface has not been formed through transition from the carrier surface covered with the fluororesin, but it covers the toner particle surface directly while aiming at toner particle, it is possible to effectively inhibit the fluorine compound from leaving from the toner particle surface, etc. to maintain the coverage ratio with stability even when image formation is performed for a long time.

Therefore, the two-component developer of the present invention can improve the stability of image density in formed images effectively even when performing image formation continuously for a long time.

It is preferred to constitute the two-component developer of the present invention as a negatively charged two-component developer.

This is because the range of the aforesaid ratio of the fluorine compound coverage on a toner particle to the fluorine compound coverage on a carrier is specified to a range suitable for toner particle to be negatively charged stably.

In the present invention, the coverage (A1) with a fluorine compound on the surface of a toner particle means a value (A1) (%) represented by the following equation (1) where a1 is an projected area of the fluorine compound measured on the basis of a photograph of the surface of the toner particle taken by using a scanning electron microscope, and b1 is an projected area of the toner particle measured in the same way.

A1(%)=a1/b1×100 (1)

On the other hand, in the present invention, the coverage (A2) with the fluorine compound in the carrier surface means a value (A2) (%) represented by the following equation (2) where the fluorescent X-ray intensity of fluorine in the carrier surface measured using an X-ray fluorescence analyzer is let be a2, and the fluorescent X-ray intensity of fluorine in the carrier surface measured in the same manner when the carrier surface is covered only with the fluorine compound used (i.e., when the carrier surface is covered only with fluororesin(fluorocarbon resin), etc. as the fluorine compound without using a thermosetting resin, etc. for firmly covering the fluorine compound) is let be b2.

A2(%)=a2/b2×100 (2)

In constituting the two-component developer of the present invention, it is preferable that the fluorine compound be at least one kind of fluororesin selected from the group consisting of polytetrafluoroethylene (PTFE), a tetrafluoroethylene-hexafluoropropylene copolymer (FEP), a tetrafluoroethylene-perfluoro(alkyl vinyl ether) copolymer (PFA), and an ethylene-tetrafluoroethylene copolymer (ETFE).

By adopting such constitution, it becomes easy to adjust the surface energy in toner particle or carriers within a predetermined range and it is possible to fix the fluorine compound firmly to the surface of toner particle or carriers.

Therefore, it is possible to effectively control the non-electrostatic adhesion force between toner particle and a carrier or a developing roll and the charging property of the toner particle.

In constituting the two-component developer of the present invention, it is preferable to adjust the coverage (A1) with the fluorine compound in the toner particle surface to a value within the range of from 4 to 14%.

By adopting such a constitution, it is possible to more stably control the non-electrostatic adhesion force between toner particle and a carrier and the charging property of the toner particle.

In constituting the two-component developer of the present invention, it is preferable to adjust the coverage (A2) with the fluorine compound in the carrier surface to a value within the range of from 0.5 to 4%.

By adopting such a constitution, it is possible to more stably control the non-electrostatic adhesion force between toner particle and a carrier and the triboelectrification property with the toner particle.

In constituting the two-component developer of the present invention, it is preferable that the fluorine compound covering a toner particle be composed of fluororesin fine particle fixed to the surface of the toner particle.

By adopting such a constitution, the fluororesin fine particle demonstrate an effect as a spacer, and therefore it is possible to control the non-electrostatic adhesion force between the toner particle and the carrier and the like more effectively.

In constituting the two-component developer of the present invention, it is preferable that the fluorine compound covering a toner particle be obtained by stirring a toner raw powder, fluororesin fine particle and inorganic fine particle together.

By adopting such a constitution, since flocculated fluororesin fine particle can be effectively dispersed by inorganic particles, fluororesin fine particle can be fixed more uniformly and more firmly to the surface of toner particle.

The inorganic fine particle as used herein exclude those externally added to the toner particle in advance.

In constituting the two-component developer of the present invention, it is preferable that the fluorine compound covering a carrier be composed of a thermosetting resin and fluororesin fine particle.

By adopting such a constitution, it is possible not only to fix a fluorine compound to the surface of a carrier firmly, but it also is possible to inhibit the degradation of the carrier effectively.

In constituting the two-component developer of the present invention, it preferably is a two-component developer that is to be used for touchdown development using a developing roll arranged in opposition to an electrostatic latent image support and a magnetic roll which forms a magnetic brush composed of toner particle and a carrier and which is arranged in opposition to the developing roll, and that is to be used for touchdown development where a first DC bias and an AC bias are supply to the developing roll and a second DC bias is supplied to the magnetic roll and a toner layer is formed on the developing roll due to the potential difference between the first DC bias and the second DC bias and due to the AC bias, and thereby a latent image is developed on the electrostatic latent image support.

By adopting such a constitution, it is possible to effectively maintain the stability of image density in formed images even in the touchdown development system where the non-electrostatic adhesion force between toner particle and a carrier or a developing roll and the stability in the charging property of toner particle are further required due to the constitution where a toner layer is formed on the developing roll.

Another embodiment of the present invention is an image forming device having a developing device that has a developing roll arranged in opposition to an electrostatic latent image support and a magnetic roll which forms a magnetic brush composed of toner particle and a carrier which constitute the two-component developer and which is arranged in opposition to the developing roll, and that adopts a touchdown developing system where a first DC bias and an AC bias are supply to the developing roll and a second DC bias is supplied to the magnetic roll and a toner layer is formed on the developing roll due to the potential difference between the first DC bias and the second DC bias and due to the AC bias, and thereby a latent image is developed on the electrostatic latent image support, wherein the surfaces of the toner particle and the carrier which constitute the two-component developer are each covered with a fluorine compound, and a ratio represented by A2/A1 is adjusted to a value within the range of from 0.1 to 0.5 where the coverage with the fluorine compound on the surface of the toner particle is let be A1 and the coverage with the fluorine compound on the surface of the carrier is let be A2.

That is, since the predetermined two-component developer is used in the present invention, it is possible to control the non-electrostatic adhesion force between toner particle and a carrier or a developing roll, and it is possible to maintain the charging property of the toner particle effectively.

Therefore, it is possible to effectively maintain the stability of image density in formed images even in the touchdown development system where the non-electrostatic adhesion force between toner particle and a carrier or a developing roll and the stability in the charging property of toner particle are further required due to the constitution where a toner layer is formed on the developing roll.

### BRIEF DESCRIPTION OF THE DRAWINGS

FIG. 1 is a diagram for illustrating the relationship between a coverage ratio (A2/A1) and an absolute value of the image density change, etc.

FIG. 2 is a diagram for illustrating the color image forming device according to the present invention.

FIG. 3 is a diagram for illustrating the touchdown developing device in the present invention.

### DETAILED DESCRIPTION OF THE PREFERRED EMBODIMENTS

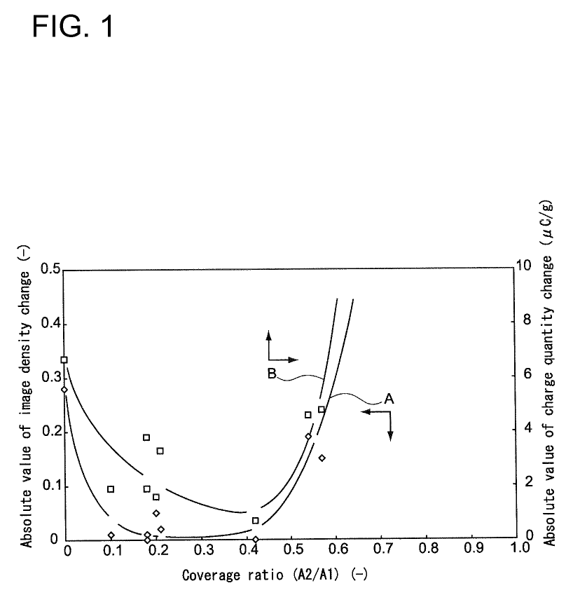

A first embodiment is a two-component developer in which the surface of toner particle and the surface of a carrier are each covered with a fluorine compound, wherein, as shown in FIG. 1, a ratio represented by A2/A1 is adjusted to a value within a range of from 0.1 to 0.5 where A1 is a coverage with the fluorine compound on the surface of the toner particle and A2 is a coverage with the fluorine compound on the surface of the carrier.

In the following, the two-component developer of the first embodiment is described by separating it into its constituent features.

### 1. Toner Particle

### (1) Toner Raw Powder

### (1)-1 Binding Resin

The kind of the binding resin used for the toner raw powder is not particularly restricted. It is preferable to use, for example, a thermoplastic resin such as a styrene resin, an acrylic resin, styrene-acrylic copolymers, a polyethylene resin, a polypropylene resin, a vinyl chloride resin, a polyester resin, a polyamide resin, a polyurethane resin, a polyvinyl alcohol resin, a vinyl ether resin, a N-vinyl resin and a styrene-butadiene resin.

### (1)-2 Coloring Agent

The kind of the coloring agent to be contained in the toner raw powder is not particularly restricted. For example, it is preferable to use carbon black, acetylene black, lampblack, aniline black, an azo pigment, yellow iron oxide, ochre, a nitro dye, an oil-soluble dye, a benzidine pigment, a quinacridone pigment, a copper phthalocyanine pigment, or the like.

The addition quantity of the coloring agent, which is not particularly restricted, is preferably adjusted, for example, to a value within the range of from 0.01 to 30 parts by weight to 100 parts by weight of the binding resin of the toner raw powder.

The reason for this is that if the addition quantity of the coloring agent is below 0.01 parts by weight, the image density is reduced and it may be difficult to obtain clear images. On the other hand, that is also because when the addition quantity of the coloring agent is above 30 parts by weight, the fixing property may deteriorate.

For such reasons, it is more preferable to adjust the addition quantity of the coloring agent to a value within the range of from 0.1 to 20 parts by weight, and even more preferably to a value within the range of from 0.5 to 15 parts by weight to 100 parts by weight of the binding resin of the toner raw powder.

### (1)-3 Charge Control Agent

It is preferable to add a charge control agent to the toner raw powder.

The reason for this is that addition of a charge control agent can greatly improve the charge level or the charge rise characteristic, which is an index showing whether a material is charged to a certain charge level or not in short time.

While the kind of such a charge control agent is not particularly restricted, organometallic complexes and chelate compounds are effective. In particular, acetylacetone metal complexes, salicylic acid-based metal complexes or salts are preferred, and salicylic acid-based metal complexes or salts are particularly preferred.

Among these, examples of the acetylacetone metal complexes include aluminum acetylacetonate and iron (II) acetylacetonate.

Examples of the salicylic acid-based metal complex or salt include chromium 3,5-di-tert-butylsalicylate.

It is preferable to adjust the addition quantity of the charge control agent to a value within the range of from 0.5 to 10 parts by weight to 100 parts by weight of the binding resin of the toner raw powder.

The reason for this is that if the addition quantity of the charge control agent is below 0.5 parts by weight, the effects due to the charge control agent may fail to be exhibited. That is also because if the addition quantity of the charge control agent is a value of over 10 parts by weight, defective charging or a defective image may easily be produced particularly under high temperature and high humidity conditions.

For such reasons, it is more preferable to adjust the addition quantity of the charge control agent to a value within the range of from 1 to 9 parts by weight, and even more preferably to a value within the range of from 2 to 8 parts by weight to 100 parts by weight of the binding resin of the toner raw powder.

### (1)-4 Wax

It is preferable to add wax to the toner raw powder.

Such wax is not particularly restricted. Examples thereof include a single substance or combinations of two or more substances selected from polyethylene wax, polypropylene wax, fluororesin wax, Fischer Tropsch wax, paraffin wax, ester wax, montan wax, rice wax, etc.

It is preferable to adjust the addition quantity of the wax to a value within the range of from 0.1 to 20 parts by weight to 100 parts by weight of the binding resin of the toner raw powder.

The reason for this is that if the addition quantity of the wax is below 0.1 parts by weight, it may become difficult to prevent image smearing or the like effectively. On the other hand, that is also because if the addition quantity of the wax is a value of over 20 parts by weight, the preservation stability may be worse due to fusion of toner particle.

For such reasons, it is more preferable to adjust the addition quantity of the wax to a value within the range of from 0.5 to 15 parts by weight, and even more preferably to a value within the range of from 1 to 10 parts by weight to 100 parts by weight of the binding resin of the toner raw powder.

### (1)-5 Volume Average Particle Diameter

The volume average particle diameter of the toner raw powder is preferably adjusted to a value within the range of from 4 to 20 μm.

The reason for this is that if the volume average particle diameter of the toner raw powder is below 4 μm, stable production may become difficult or the cleaning efficiency of residual toner may be reduced. On the other hand, that is also because if the volume average particle diameter of the toner raw powder is a value of over 20 μm, it may become difficult to obtain high-quality images.

For such reasons, it is more preferable to adjust the volume average particle diameter of the toner raw powder to a value within the range of from 5 to 12 μm, and even more preferably to a value within the range of from 6 to 10 μm.

The volume average particle diameter of the toner raw powder can be measured using, for example, a Coulter multisizer 3 available from Beckman Coulter, Inc.

### (1)-6 Average Degree of Circularity

It is preferable to adjust the average degree of circularity of the toner raw powder to a value of 0.9 or more.

The reason for this is that by adjusting the average degree of circularity of the toner raw powder to a value within that range, it is possible to control the adhesive property of resulting toner particle more effectively.

That is, if the average degree of circularity of the toner raw powder becomes a value of below 0.9, the specific surface area thereof increases excessively and, as a result, it may become difficult to cover the powder uniformly with a fluorine compound or it may become difficult to control the adhesive property of the powder to a developing roll or a carrier effectively. That is also because if the average degree of circularity of the toner raw powder is adjusted to an excessively large value, it may become difficult to fix a fluorine compound firmly to the surface of the powder.

For such reasons, it is more preferable to adjust the average degree of circularity of the toner raw powder to a value within the range of from 0.91 to 0.99, and even more preferably to a value within the range of from 0.92 to 0.98.

The average degree of circularity in the present invention is an arithmetic average of values defined by the following equation (3).

Degree of circularity a=L₀/L (3)

In equation (3), L₀ represents the length of the perimeter of a circle having the same projected area as the particle image of the toner raw powder and L represents the length of the perimeter of the particle image of the toner raw powder.

### (2) Fluorine Compound Covering

The toner particle in the present invention are characterized by being covered with a fluorine compound on their surface.

The reason for this is that, by covering the surface of a toner particle and, as described later, the surface a carrier with a fluorine compound, and adjusting the ratio of the coverages to within a predetermined range, it is possible to stably control the non-electrostatic adhesion force between toner particle and a carrier or a developing roll and the charging property of the toner particle.

That is also because, as a result of the above, it is possible to improve the stability of the image density in formed images even when image formation is performed continuously for a long time.

### (2)-1 Kind

While the fluorine compound to be used may be any conventionally known fluorine compound, it is particularly preferable that the fluorine compound be at least one kind of fluororesin selected from the group consisting of polytetrafluoroethylene (PTFE), a tetrafluoroethylene-hexafluoropropylene copolymer (FEP), a tetrafluoroethylene-perfluoro (alkyl vinyl ether) copolymer (PFA), and an ethylene-tetrafluoroethylene copolymer (ETFE).

The reason for this is that if such a fluororesin is used, it becomes easy to adjust the surface energy in toner particle to within a predetermined range and it is possible to fix the compound firmly to the surface of toner particle or a carrier.

That is also because it becomes easy to adjust the charging property of the toner particle to within a predetermined range.

### (2)-2 Coverage

It is preferable to adjust the coverage (A1) with a fluorine compound on the surface of toner particle to a value within the range of from 4 to 14%.

The reason for this is that by adjusting the coverage (A1) with a fluorine compound on the surface of a toner particle within that range, it is possible to control more stably the non-electrostatic adhesion force between toner particle and a carrier, etc. and the charging property of the toner particle.

That is, if the coverage (A1) with the fluorine compound on the surface of a toner particle becomes a value of below 4%, it becomes difficult to reduce the surface energy in the toner particle sufficiently and it becomes difficult to cover the toner particle sufficiently, and as a result, the image density may decrease. That is also because if the coverage (A1) with a fluorine compound on the surface of a toner particle becomes a value of over 14%, the charge quantity of the toner particle will become excessive and, as a result, the image density may tend to increase.

For such reasons, it is more preferable to adjust the coverage (A1) with a fluorine compound on the surface of a toner particle to a value within the range of from 4.2 to 10%, and even more preferably to a value within the range of from 4.5 to 9.5%.

The measuring method of the coverage (A1) with a fluorine compound on the surface of a toner particle will be described in Examples shown later.

### (3) Production Method

### (3)-1 Preparation of Toner Raw Powder

In the preparation of a toner raw powder, a resin composition for a toner is prepared first by preliminarily mixing the aforementioned binding resin, wax, coloring agent and, if necessary, other additives by a conventional method, followed by melt-kneading. It is preferable to obtain a toner raw powder by subsequently finely grinding the resulting resin composition for a toner using a conventional method and then subjecting it to sizing.

The preliminary mixing is conducted preferably by using, for example, a Henschel mixer, a ball mill, a super mixer, a dry blender, or the like.

The melt-kneading is conducted preferably by using, for example, a twin screw extruder, a single screw extruder, or the like. The finely grinding is conducted preferably by using, for example, an air granulator, or the like. The classification is conducted preferably by using, for example, an air classifier, or the like.

(3)-2 Covering with Fluorine Compound

In the present invention, the method for covering the surface of toner particle with a fluorine compound is not particularly restricted. While any method by which it is possible to make the fluorine compound cover the surface of the toner particle directly, such as an immersion application method, a spray application method and a fluidized bed application method, may be used, it is preferable to use a method in which the fluororesin fine particle are fixed to the surface of the toner particle.

The reason for this is that when the surface of toner particle is covered with fluororesin fine particle, the fluororesin fine particle demonstrate an effect as a spacer, and therefore it is possible to control the non-electrostatic adhesion force between the toner particle and carriers, etc. more effectively.

Therefore, the method for covering the surface of toner particle with fluororesin fine particle will be described below.

### (i) Preparation of Fluororesin Fine Particle

As the method for the preparation of fluororesin fine particle, conventional methods, such as a stirring granulation method, an emulsion polymerization method and a spray dry method, can be used.

It is preferable to adjust the volume average particle diameter of the fluororesin fine particle to a value within the range of from 30 to 500 nm.

The reason for this is that if the volume average particle diameter of the fluororesin fine particle becomes a value of below 30 nm, the particles will tend to flocculate so easily that it may become difficult to fix the particles to the surface of a toner raw powder uniformly and firmly. That is also because if the volume average particle diameter of the fluororesin fine particle is a value over 500 nm, the repellence between the particles and the toner raw powder will become so strong that it may become difficult to fix the particles to the surface of the toner raw powder uniformly and firmly.

Therefore, it is more preferable to adjust the volume average particle diameter of the fluororesin fine particle to a value within the range of from 50 to 200 nm, and even more preferably to a value within the range of from 70 to 150 nm.

The volume average particle diameter of fluororesin fine particle can be measured using a scanning electron microscope.

### (ii) Fixation of Fluororesin Fine Particle

It is preferable to use, as the method for fixing fluororesin fine particle to the surface of a toner raw powder, a dry mechanical impact method, that is, a method in which the fluororesin fine particle and the toner raw powder are stirred together under a strong stirring power to fix together due to collision of these particles.

The stirring machine to be used here may be a Henschel mixer, for example.

It is preferable to adjust the addition quantity of the fluororesin fine particle to a value within the range of from 0.1 to 10 parts by weight to 100 parts by weight of the toner raw powder.

This is because if the addition quantity of the fluororesin fine particle is a value out of the range of from 0.1 to 10 parts by weight, it may become difficult to adjust the coverage (A1) with the fluorine compound on the surface of the toner particle to within a predetermined range.

For such reasons, it is more preferable to adjust the addition quantity of the fluororesin fine particle to a value within the range of from 0.5 to 5 parts by weight, and even more preferably to a value within the range of from 1 to 3 parts by weight to 100 parts by weight of the toner particle.

At this time, it is preferable to add inorganic particles in addition to the fluororesin fine particle and the toner raw powder and stir them together.

The reason for this is that since it is possible to disperse flocculated fluororesin fine particle effectively by adding inorganic particles such as silica fine particle and titanium oxide fine particle, the fluororesin fine particle can be fixed to the surface of toner particle more uniformly and more firmly.

The inorganic fine particle as used herein exclude those externally added to the toner raw powder in advance.

The reason for this is that the use of inorganic fine particle in a state that they have been added externally to the toner raw powder will make insufficient the number of inorganic fine particle which contribute to improvement in dispersibility of fluororesin fine particle and that it may serve as a major factor to inhibition of stable fixation of fluororesin fine particle to the surface of the toner raw powder surface.

It is preferable to adjust the volume average particle diameter of the inorganic fine particle to a value within the range of from 5 to 50 nm.

The reason for this is that if the volume average particle diameter of the inorganic fine particle is a value of below 5 nm, the inorganic fine particle may flocculate excessively easily. That is also because if the volume average particle diameter of the inorganic fine particle is a value of over 50 nm, the inorganic fine particle tend to leave excessively easily from the toner particle and therefore it may be come difficult to cause them to demonstrate, in a completed two-component developer, an effect as an external additive.

For such reasons, it is more preferable to adjust the volume average particle diameter of the inorganic fine particle to a value within the range of from 7 to 40 nm, and even more preferably to a value within the range of from 10 to 30 nm.

The volume average particle diameter of inorganic fine particle can be measured using a scanning electron microscope.

It is preferable to adjust the addition quantity of the inorganic fine particle to a value within the range of from 0.3 to 5 parts by weight to 100 parts by weight of the toner raw powder.

The reason for this is that if the addition quantity of the inorganic fine particle is a value out of the range of from 0.3 to 5 parts by weight, it may become difficult to cause them to sufficiently demonstrate an effect of improving the dispersibility of resin fine particle or it may become difficult to cause them to sufficiently demonstrate, in a completed two-component developer, an effect as an external additive of improving the fluidity of toner particle.

For such reasons, it is more preferable to adjust the addition quantity of the inorganic fine particle to a value within the range of from 0.5 to 4 parts by weight, and even more preferably to a value within the range of from 0.8 to 3 parts by weight to 100 parts by weight of the toner raw powder.

### 2. Carrier

### (1) Carrier Core

### (1)-1 Kind

Examples of the carrier core include metal or alloy which shows ferromagnetism, such as ferrite, magnetite, iron, cobalt and nickel, or compounds containing such ferromagnetic elements, or alloy which is free of ferromagnetic elements but which will show ferromagnetism through application of appropriate heat treatment.

It is also desirable to use, as a carrier core, a material obtained by dispersing the above-mentioned magnetic powder in a binder resin, such as a polyvinyl alcohol resin and a polyvinyl acetal resin, followed by granulation. That is, core elementary particles can be obtained by mixing and dispersing a magnetic powder, a binder resin and, according to demand, additives or the like, followed by granulation and drying. Thereafter, a carrier core can be obtained by calcining and then pulverizing the resulting carrier core elementary particles using a conventional method.

### (1)-2 Volume Average Particle Diameter

It is preferable to adjust the volume average particle diameter of the carrier to a value within the range of from 20 to 120 μm.

The reason for this is that if volume average particle diameter of the carrier is a value of below 20 μm, carrier jumping may tend to occur. On the other hand, that is also because if the volume average particle diameter of the carrier is a value of over 120 μm, a sufficient charging ability may fail to be obtained.

For such reasons, it is more preferable to adjust the volume average particle diameter of the carrier to a value within the range of from 25 to 100 μm, and even more preferably to a value within the range of from 30 to 90 μm.

The volume average particle diameter of a carrier can be measured by combining sieves which are different from each other in opening size.

(2) Covering with Fluorine Compound

The carrier in the present invention is characterized by being covered with a fluorine compound on its surface.

The reason for this is that, as already described in the section of toner particle, by covering the surface of a toner particle and the surface a carrier with a fluorine compound, and adjusting the ratio of the coverages to within a predetermined range, it is possible to stably control the non-electrostatic adhesion force between toner particle and a carrier or a developing roll and the charging property of the toner particle.

That is also because, as a result of the above, it is possible to improve the stability of the image density in formed images even when image formation is performed continuously for a long time.

As a fluorine compound to be used, one which is the same as the fluorine compound used to the a fore said toner particle can be used.

### (2)-1 Coverage

It is preferable that the coverage (A2) with a fluorine compound on the surface of a carrier be adjusted to a value within the range of from 0.5 to 4%.

The reason for this is that by adjusting the coverage (A2) with a fluorine compound on the surface of a carrier to within that range, it is possible to control the non-electrostatic adhesion force of toner particle and a carrier and the triboelectrification property of toner particle more stably.

In other words, that is because if the coverage (A2) with a fluorine compound on the carrier surface is a value of below 0.5%, the charge quantity of toner particle may become insufficient and it may become difficult to obtain a sufficient image density. That is also because if the coverage (A2) with a fluorine compound on the carrier surface is a value of over 4%, it may become difficult to stabilize toner particle.

For such reasons, it is more preferable to adjust the coverage (A2) with a fluorine compound on the surface of a carrier to a value within the range of from 0.8 to 2.5%, and even more preferably to a value within the range of from 1 to 2%.

The measuring method of the coverage (A2) with a fluorine compound on the surface of a carrier will be described in Examples shown later.

### (2)-2 Thickness

It is preferable to adjust the thickness of the fluorine compound coat on the carrier surface to a value within the range of from 5 to 30 μm.

The reason for this is that if the thickness of the fluorine compound coat on the carrier surface is a value outside that range, it may become difficult to obtain a predetermined surface energy and a predetermined charging property and also it may become difficult to make the fluorine compound be adhered uniformly or the fluorine compound may tend to leave off.

For such reasons, it is more preferable to adjust the thickness of the fluorine compound coat on the carrier surface to a value within the range of from 7 to 25 μm, and even more preferably to a value within the range of from 10 to 20 μm.

### (3) Addition Quantity

It is preferable to adjust the addition quantity of the carrier to a value within the range of from 500 to 5000 parts by weight to 100 parts by weight of the toner particle.

The reason for this is that if the addition quantity of the carrier is a value of below 500 parts by weight, it may become difficult to sufficiently triboelectrically charge toner particle. On the other hand, that is also because if the addition quantity of the carrier is a value of over 5000 parts by weight, the fluidity of the developer as a whole may deteriorate or carrier jumping may tend to occur.

For such reasons, it is more preferable to adjust the addition quantity of the carrier to a value within the range of from 600 to 3000 parts by weight, and even more preferably to a value within the range of from 700 to 2000 parts by weight to 100 parts by weight of the toner particle.

### (4) Method for Covering Carrier Core

In the present invention, regarding the method for covering the surface of a carrier with a fluorine compound which is not particularly restricted, it is preferable, for example, to coat a carrier core with a solution prepared by dissolving a fluorine compound in a proper solvent, by the use of a proper means such as spraying or a fluidized bed. It is also desirable to dry and calcine the resulting mixed mass of the covering resin and the carrier core, pulverize it with a hammer mill or the like, and further subject it to classification treatment using an air classifier or the like.

It is preferable that the fluorine compound be composed of a thermosetting resin and fluororesin fine particle.

The reason for this is that when the fluorine compound is composed of a thermosetting resin and fluororesin fine particle, it is possible not only to fix the fluorine compound to the surface of a carrier firmly, but it also is possible to inhibit the degradation of the carrier effectively.

In other words, that is because by using the mixed composition obtained by mixing fluororesin fine particle into a thermosetting resin, it is possible to fix such a coat firmly even if the temperature in a developing device rises.

As a result, it is possible not only to control the non-electrostatic adhesion force of a carrier and the triboelectrification property with toner particle more stably, but also to effectively improve the mechanical strength of a carrier, which stays in a developing device for a longer time than toner particle and therefore the inhibition of the degradation which becomes a problem.

The property of a carrier can be adjusted easily by changing the content of the fluororesin fine particle in the thermosetting resin.

Examples of the aforesaid thermosetting resin include an epoxy resin, a phenol resin, a melamine resin, a polyamide resin, an urea resin, an unsaturated polyester resin, an alkyd resin, a polyurethane resin, and a thermosetting polyimide resin.

The details of the fluororesin fine particle are omitted here because they were already described in the section of the toner particle.

### 3. Coverage Ratio

The present invention is characterized in that a ratio represented by A2/A1 is adjusted to a value within the range of from 0.1 to 0.5, where the coverage with a fluorine compound on the surface of a toner particle is let be A1 and the coverage with the fluorine compound on the surface of a carrier is let be A2.

The reason for this is that by covering the surface of a toner particle with a fluorine compound and covering the surface of a carrier with a fluorine compound and adjusting the ratio of the coverage (A1) of the toner surface and the coverage (A2) of the carrier surface to within a predetermined range, it is possible to control the non-electrostatic adhesion force between toner particle and carrier particles or a developing roll and to maintain the charging property of the toner particle effectively.

In other words, that is because if the ratio represented by A2/A1 becomes a value of below 0.1, the coverage with the fluorine compound on the toner particle surface becomes excessively smaller than the coverage with the fluorine compound on the carrier surface, so that the toner particle becomes easy to be charge excessively and, therefore, the image density may tend to change. On the other hand, that is also because if the ratio represented by A2/A1 becomes a value of over 0.5, it becomes difficult to charge the toner particle sufficiently and, therefore, the image density may tend to change.

For such reasons, it is more preferable to adjust the ratio represented by A2/A1 to a value within the range of from 0.15 to 0.45, and even more preferably to a value within the range of from 0.2 to 0.42.

Next, with reference to FIG. 1, the ratio represented by A2/A1 (coverage ratio), the change in image formation density and the change in toner charge quantity between before and after continuous image formation are explained.

In FIG. 1 shown are a characteristic curve A in which the abscissa denotes the ratio (coverage ratio) (−) represented by A2/A1 and the left ordinate denotes the absolute value of the image density change (−) in a formed image, and a characteristic curve B in which the right ordinate denotes the absolute value of the toner charge quantity change (μC/g) in a toner layer formed on a developing roll.

The absolute value of the image density change in a formed image means the absolute value of the image density change in 25% half images generated between before and after 50,000-sheet single-shot printing of a predetermined character image having a printing rate of 2%. The absolute value of the toner charge quantity change in a toner layer formed on a developing roll means the absolute value of the toner charge quantity change generated before and after 50,000-sheet single-shot printing of a predetermined character image having a printing rate of 2%.

First, characteristic curve A shows that as the value of the coverage ratio (A2/A1) increases, the absolute value of the image density change decreases once, and then it increases again.

More specifically, it is shown that as the coverage ratio (A2/A1) increases from 0 to 0.1, the absolute value of the image density change decreases rapidly from about 0.3 to a value of 0.1 or less. It is also shown that within a range where the coverage ratio (A2/A1) is from 0.1 to 0.5, despite the change in coverage ratio, the absolute value of the image density change is maintained at a value of 0.1 or less stably. On the other hand, in a range where the coverage ratio (A2/A1) is over 0.5, with increase in coverage ratio, the absolute value of the image density change continues increasing and it can not maintain a value of 0.1 or less.

Characteristic curve B also shows that as the value of the coverage ratio (A2/A1) increases, the absolute value of the toner charge quantity change decreases once, and then it increases again.

More specifically, it is shown that as the coverage ratio (A2/A1) increases from 0 to 0.1, the absolute value of the toner charge quantity change decreases rapidly from about 6 μC/g to a value of 4 μC/g or less. It is also shown that within a range where the coverage ratio (A2/A1) is from 0.1 to 0.5, despite the change in coverage ratio, the absolute value of the toner charge quantity change is maintained at a value of 4 μC/g or less stably. On the other hand, in a range where the coverage ratio (A2/A1) is over 0.5, with increase in coverage ratio, the absolute value of the toner charge quantity change continues increasing and it can not maintain a value of 4 μC/g or less.

Therefore, characteristic curves A and B show that by adjusting the coverage ratio (A2/A1) to a value within the range of 0.1 to 0.5, it is possible to critically stabilize the charge property of toner particle and the image density caused thereby even if the image formation is performed for a long time.

A second embodiment is an image forming device having a developing device that has a developing roll arranged in opposition to an electrostatic latent image support and a magnetic roll which forms a magnetic brush composed of toner particle and a carrier and which is arranged in opposition to the developing roll, and that adopts a touchdown developing system where a first DC bias and an AC bias are supply to the developing roll and a second DC bias is supplied to the magnetic roll and a toner layer is formed on the developing roll due to the potential difference between the first DC bias and the second DC bias and due to the AC bias, and thereby a latent image is developed on the electrostatic latent image support, wherein the surfaces of the toner particle and the carrier which constitute the two-component developer are each covered with a fluorine compound, and a ratio represented by A2/A1 is adjusted to a value within the range of from 0.1 to 0.5 where the coverage with the fluorine compound on the surface of the toner particle is let be A1 and the coverage with the fluorine compound on the surface of the carrier is let be A2.

In the following, an image forming device as the second embodiment is described with concentration on a developing device, which is the characteristic part in the image forming device of the present invention, while contents which duplicate those of the first embodiments are omitted.

### 1. Basic Constitution

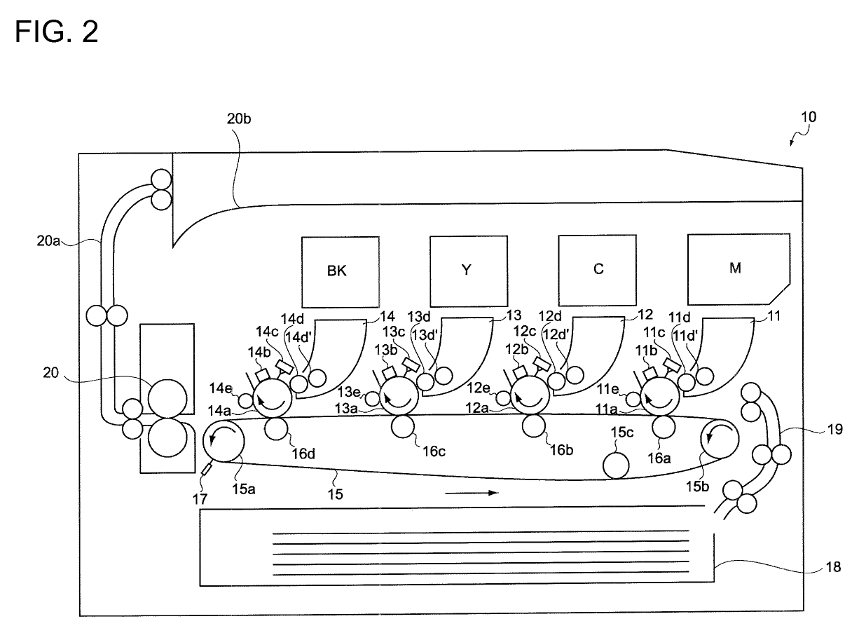

FIG. 2 is a diagram showing a color image forming device as one example of the image forming device of the present invention. The color image forming device 10 has an endless belt (conveying belt) 15, which is configured so as to convey recording papers supplied from a paper feeding cassette 18 toward a fixing device 20. Above the endless belt 15, touchdown developing devices, namely, a developing device 11 for magenta, a developing device 12 for cyan, a developing device 13 for yellow, and a developing device 14 for black are arranged along the conveying direction of recording papers. The touchdown developing devices 11 to 14 have feed rollers (magnetic rollers) 11d′ to 14d′ and developing rollers 11d to 14d, and a toner thin layer can be formed on developing rollers 11d to 14d by a touchdown development system.

In opposition to developing rollers 11d to 14d, photoconductor drums 11a to 14a, which are image supports, are arranged. Around the photoconductor drums 11a to 14a, electrification vessels 11b to 14b, exposure devices 11c to 14c, etc. are arranged. After photoconductor drums 11a to 14a are charged with electrification vessels 11b to 14b, photoconductor drums 11a to 14a are exposed to light with exposure devices 11c to 14c depending on image data. In such a manner, electrostatic latent images are formed on photoconductor drums 11a to 14a. Subsequently, the electrostatic latent images on photoconductor drums 11a to 14a are developed with developing rollers 11d to 14d and thereby color toner images are formed.

On a recording paper carried by endless belt 15, the color toner images are transferred one after another with the transfer devices 16a to 16d and thereby a color toner image is formed. Then, the recording paper is carried to an fixing device 20, and the color toner image is fixed there and the recording paper is ejected via a paper ejection path.

### 2. Developing Device

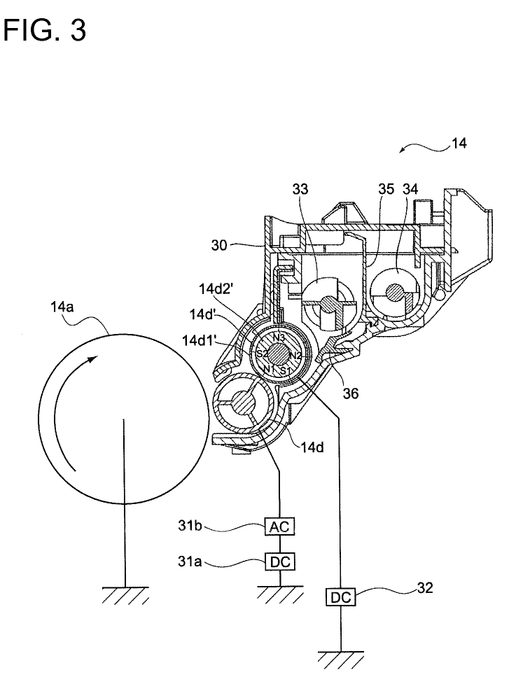

Next, with reference to FIG. 3, a more detailed explanation is made by taking a touchdown developing device 14 as an example.

The touchdown developing device 14 has a magnetic roller (feed roller) 14d′ and a developing roller 14d. Magnetic roller 14d′ has a cylindrical rotation sleeve 14d1′ made of non-magnetic metallic material and a fixed magnet 14d2′ arranged inside the rotating sleeve. In fixed magnet 14d2′, a plurality of magnetic poles are formed. Magnetic roller 14d′ and developing roller 14d are placed in a developing vessel 30. There is a configuration where to developing roller 14d, a DC bias Vdc1 (first DC bias) is applied from a direct current (DC) bias supply 31a, and an AC bias Vac is applied from an alternating current (AC) bias supply 31b. Moreover, there is a configuration where a DC bias Vdc2 (second DC bias) is applied from a direct current (DC) bias supply 32 to magnetic roller 14d′. Bias supplies 31a and 32 are controlled with a control unit, which is not shown.

It is preferable to adjust the first DC bias to a value within the range of from −50 to −400 V, and regarding the AC bias, it is preferable to adjust the peak-peak value to a value within the range of from 500 to 2000 V and the frequency to a value within the range of from 1 to 3 kHz.

In developing vessel 30, a paddle mixer 33 and a stirring mixer 34 are provided, and a partition board 35 is arranged between paddle mixer 33 and stirring mixer 34. The two-component developer contained in developing vessel 30 is charged while being stirred and conveyed with stirring mixer 34. The developer is fed to a magnetic roller 14d′ while being stirred and charged with paddle mixer 33. An ear cutting blade (layer thickness regulating blade) 36 is provided in opposition to magnetic roller 14d′. With the layer thickness regulating blade 36, the height of a magnetic brush formed on magnetic roller 14d′ is regulated. Partition board 35 has a length in its longitudinal direction (the axial direction of developing roller 14d) which is shorter than the width of developing vessel 30, so that a developer can pass at both ends of partition board 35.

Depending on the absolute value of the potential difference between the DC bias (Vdc2) and the DC bias (Vdc1), ((Vdc2)−(Vdc1)), which is henceforth called a delta value, the thickness of a toner layer on developing roller 14d is regulated. For example, when the delta value is increased, the toner thin layer on developing roller 14d becomes thicker; whereas when the delta value is decreased, the toner thin layer becomes thinner.

Therefore, under such control of the thickness of a toner thin layer, depending on the potential difference between a photoconductor drum 14a and developing roller 14d, a toner flies from the toner thin layer on developing roller 14d to an electrostatic latent image formed on photoconductor drum 14a. Thereby, touchdown development is performed.

It is preferable to adjust the delta value to a value within the range from 100 to 200 V.

As described above, the touchdown development system is a development system in which only charged toner particle (including additives) are supported on a developing roll and caused to fly to an electrostatic latent image.

Therefore, it is advantageous, over common two-component development systems in which development is performed by forming a magnetic brush, in that it is excellent in dot reproducibility, that it can increase the life in developing devices and latent image supports, and that high-speed image formation can be performed easily.

On the other hand, when the touchdown development system is adopted, the non-electrostatic adhesion force between toner particle and a carrier, etc. and the stability in the charging property of toner particle are further required due to the constitution where a toner layer is formed on a developing roll.

In the touchdown development system, an monocomponent developer layer is formed on a developing roll from a two-component developer layer (magnetic brush) on a magnetic roll, and a developed layer is formed on the latent image on an electrostatic latent image support. In this course, the quantities of the monocomponent developer layer and developed layer and the charge quantity are determined through adjustment of the potential of bias applied to the magnetic roll and the developing roll which work for transfer and layer formation of a toner.

The bias applied to a magnetic roll and a developing roll is determined by bias calibration. More specifically, it is determined by measuring the quantity of toner (600 dpi, 25% half) on a transfer belt. This is based on a premise that as the bias of a magnetic roll rises, the quantity of development increases and that the larger the bias difference between the magnetic roll and the developing roll, the greater the thickness of a toner layer on the developing layer.

However, while an operation, for example, that a toner layer on a developing roll is removed (a residual toner layer on a developing layer is removed onto a magnetic roll) by application of reverse bias is commonly practiced as initialization of a developing roll, such removal of a toner layer is not necessarily performed at every image formation because of the necessity of achieve a predetermined image formation efficiency.

As a result, even when a bias applied to a magnetic roll and a developing roll is adjusted by bias calibration, it may be difficult to maintain the thickness of the toner layer on the developing roll stably within a predetermined range.

Moreover, there is a problem that the thickness of a toner layer on a developing roll becomes unstable and, as a result, the development quantity to a latent image support also becomes unstable, which will cause unstabilization of image density, such as change in color and unevenness in images.

Therefore, when the touchdown development system is adopted, there arises a necessity of stably forming a toner layer having a predetermined thickness on a developing roll by increasing the non-electrostatic adhesion force between toner particle and a carrier or developing roll or the stability in charging property of the toner itself before adjusting the bias to be applied to the magnetic roll and developing roll.

In this regard, in the two-component developer used in the present invention, the toner particle surface and the carrier surface are each covered with a fluorine compound and the coverage ratio is regulated to within a predetermined range as described in detail in the first embodiment.

Therefore, since it is possible to form a toner layer having a predetermined thickness stably on the developing roll by effectively improving the non-electrostatic adhesion force between toner particle and the carrier or the developing roll and the stability in the charging property of the toner itself, the image density of formed images can be maintained stably even in the touchdown development system.

### EXAMPLES

The present invention is described concretely with reference to examples, but it is needless to say that the invention is not limited the contents thereof.

### 1. Preparation of Silica

### (1) Preparation of Silica A

Silica A was prepared as follows.

In a vessel, 100 g of dimethyl polysiloxane and 100 g of 3-aminopropyl trimethoxysilane (both produced by Shin-Etsu Chemical Co., Ltd.) were dissolved in 200 g of toluene, followed by dilution to 10 times by addition of toluene. Thereby, a diluted solution was obtained.

Subsequently, the resulting diluted solution was dropped slowly to 200 g of fumed silica (AEROSIL 90, produced by NIPPON AEROSIL Co., Ltd.) and stirred. Then, ultrasonic irradiation and stirring were performed for 30 minutes to yield a mixture.

Subsequently, the resulting mixture was heated in a high temperature bath at 150° C., and then toluene was distilled off using a rotary evaporator to yield a solid.

The resulting solid was dried with a vacuum dryer at a set temperature of 50° C. until, the resulting solid was dried until no weight loss is detected.

Then, the dried solid was heated under a nitrogen flow at 200° C. for 3 hours in an electric furnace to yield a powder.

Finally, the resulting powder was pulverized with a jet mill to yield silica fine particle with an average particle diameter of 0.020 μm.

### (2) Preparation of Silica B

Silica B was prepared in the same manner as silica A, except that 200 g of dimethyl polysiloxane was used instead of 100 g of dimethyl polysiloxane and 100 g of 3-aminopropyl trimethoxysilane. The average particle diameter of silica B was 0.020 μm.

### 2. Preparation of Fluororesin Fine Particle

### (1) Preparation of Resin Fine Particle A

Resin fine particle A were prepared as follows.

That is, into a 10-liter autoclave equipped with a stirrer, 5 liter of water, 2.7 kg of trichlorotrifluoroethane, 0.5 kg of methanol, 0.29 kg of perfluoro (propylvinyl ether), and 0.75 kg of tetrafluoroethylene were charged and stirred to obtain a mixed solution. Then, the inside of the container was heated and pressurized to 50° C. and 13 kg/cm².

Subsequently, to the mixed solution under these conditions, a 1% solution of di(perfluorobutyryl) peroxide in trichlorotrifluoroethane as a polymerization initiator was added intermittently, in a total quantity of 18 parts by weight to 100 parts by weight of the mixed solution, to perform polymerization so as to maintain the polymerization rate constant.

In this course, since the pressure tended to decrease with the progress of the polymerization, tetrafluoroethylene was further added so that the pressure might become fixed.

Then, when the total added quantity of tetrafluoroethylene became 1.1 kg, the temperature in the autoclave was lowered to room temperature and then the unreacted monomer was purged to yield a slurry-like liquid.

Subsequently, the resulting slurry-like liquid was transferred to a 20-liter granulation vessel, and 5 l of water was added thereto. The temperature was raised to 70° C. under stirring at a rate of 250 rpm with a puddle stirring blade, and then granulation was performed under evaporation of trichlorotrifluoroethane to yield granules having an average diameter of 0.11 μm.

Subsequently, 1 kg of the resulting granules was charged to a 4-liter autoclave. After hermetical sealing, the inside of the autoclave was fully replaced by nitrogen gas.

The inside of the autoclave was then pressurized to 2 kg/cm² with a mixed gas having a fluorine gas/nitrogen gas ratio of 20/80 (molar ratio), and maintained at 230° C. for 4 hours.

Finally, the inside of the autoclave was cooled to room temperature, and then unreacted fluorine gas was purged and the inside of the autoclave was replaced fully with nitrogen. Thus, tetrafluoroethylene-perfluoroalkyl vinylether copolymer (PFA) fine particle were obtained.

### (2) Preparation of Resin Fine Particle B

In preparation of resin fine particle B, tetrafluoroethylene-perfluoroalkylvinylether copolymer (PFA) fine particle were obtained in the same manner as resin fine particle A, except that the stirring rate with a puddle stirring blade in the granulation vessel was changed to 100 rpm.

### (3) Preparation of Resin Fine Particle C

Resin fine particle C were prepared as follows.

First, tetrafluoroethylene and hexafluoropropylene were polymerized together by emulsion polymerization in an aqueous medium in the presence of ammonium peroxodisulfate, ammonium perfluorocarboxylate, and higher paraffin. Thus, an aqueous dispersion containing 30% of tetrafluoroethylene-hexafluoropropylene copolymer (FEP) (tetrafluoroethylene/hexafluoropropylene=89/11 (molar ratio)) particles was obtained.

Subsequently, to the resulting aqueous dispersion, polyoxyethylene isotridecyl ether (DISPANOL TOC, produced by NOF Corporation) was added in a quantity of 10 parts by weight to 100 parts by weight (on a polymer solid weight basis) of the tetrafluoroethylene-hexafluoropropylene copolymer (FEP).

Subsequently, an aqueous ammonia was added so that the aqueous dispersion resulting after the addition of the polyoxyethylene isotridecyl ether might become pH 9. Then, the temperature was increased to 55° C. and a concentrated liquid having a solid concentration of about 62% was obtained by the layer separation method by leaving at rest.

Subsequently, by addition, to the resulting concentrated liquid, of polyoxyethylene isotridecyl ether in a quantity of 0.5 parts by weight to 100 parts by weight (on a polymer solid weight basis) of the tetrafluoroethylene-hexafluoropropylene copolymer (FEP), pure water and aqueous ammonia, an aqueous dispersion of tetrafluoroethylene-hexafluoropropylene copolymer (FEP) having a solid concentration of 60% was obtained. The content of the polyoxyethylene isotridecyl ether at this time was 6 parts by weight to 100 parts by weight (on polymer solid weight basis) of the tetrafluoroethylene-hexafluoropropylene copolymer (FEP).

Finally, tetrafluoroethylene-hexafluoropropylene copolymer (FEP) fine particle were obtained by separating a small portion of the resulting aqueous dispersion, followed by removal of water and extraction with acetone.

### (4) Preparation of Resin Fine Particle D

Resin fine particle D were prepared as follows.

Into a 10-liter autoclave equipped with a stirrer, 6 l of deionized water, 60 g of paraffin wax (melting point=53° C.), and 9 g of ammonium perfluorooctanate were charged and then the autoclave was hermetically sealed. Thereafter, the mixture was stirred at a rate of 250 rpm while heating at 73° C.

Subsequently, when the temperature reached 73° C., nitrogen was added into the autoclave to pressurize to 20 kg/cm², and a pressure test was conducted.

After stopping the stirring, the added nitrogen was discharged, followed by reduced pressure treatment for five minutes in order to remove oxygen from the mixed solution in the autoclave.

Subsequently, after returning to a normal pressure state, stirring was restarted and tetrafluoroethylene was added into the autoclave to increase the pressure to 18 kg/cm².

At this point of time, disuccinic acid peroxide was added to the mixed solution in the autoclave and tetrafluoroethylene was further added to maintain a pressure of 19 kg/cm². In this course, ammonium sulfite was added at some conversion stages during the polymerization in the mixed solution.

Subsequently, in order to obtain polymer latex having an average particle diameter of 0.1 μm, the polymerization reaction was stopped and the pressure in the autoclave was reduced to normal pressure when the solid content reached about 30%. Moreover, the autoclave was flashed three times with nitrogen.

Finally, a wax component was removed by decantation and the product was isolated by the solidification method. The product was heated at 200° C. for 8 hours in an oven. Thus, tetrafluoroethylene (PTFE) fine particle were obtained.

### 3. Preparation of Toner Raw Powder

Into a Henschel mixer, 100 parts by weight of a styrene-acrylic resin as a binding resin, 4 parts by weight of a mold release agent, 12 parts by weight of carbon black as a coloring agent, and 1 part by weight of a charge control agent were charged and mixed. Then, the resulting mixture was melt-kneaded in an extruder and cooled with a drum flaker. Subsequently, the resulting flakes were coarsely pulverized with a hammer mill, then finely pulverized with a turbo mill, and finally classified with an air classifier to yield a toner raw powder having a volume average particle diameter of 9.09 μm and an average degree of circularity of 0.929.

### 4. Preparation of Toner Particle

### (1) Preparation of Toner Particle A

Production of toner particle A was conducted as follows.

That is, toner particle A were obtained by charging 2 kg (100 parts by weight) of toner raw powder, 30 g (1.5 parts by weight) of silica B, and 20 g (1 part by weight) of resin fine particle A into a Henschel mixer, and stirring them at 30 m/s for 3 minutes.

The fluorine compound coverage (A1) of the resulting toner particle was measured.

That is, A1 (%) was obtained from the following equation (1) where a1 is an projected area of the fluororesin fine particle obtained on the basis of a photograph of the surface of the toner particle taken by using a scanning electron microscope (a field emission scanning electron microscope JSM-7401F, manufactured by JEOL Ltd.), and b1 is an projected area of the toner particle measured in the same way.

The fundamental constitutions of toner particle A-J are shown in Table 1.

A1(%)=a1/b×100 (1)

### (2) Preparation of Toner Particle B

Toner particle B were produced in the same manner as toner particle A, except that the addition quantity of resin fine particle A was changed to 10 g (0.5 parts by weight).

### (3) Preparation of Toner Particle C

Toner particle C were produced in the same manner as toner particle A, except that 30 g (1.5 parts by weight) of resin fine particle B was added as resin fine particle.

### (4) Preparation of Toner Particle D

Toner particle D were produced in the same manner as toner particle A, except that 20 g (1 part by weight) of resin fine particle C was added as resin fine particle.

### (5) Preparation of Toner Particle E

Toner particle E were produced in the same manner as toner particle A, except that 20 g (1 part by weight) of resin fine particle D was added as resin fine particle.

### (6) Preparation of Toner Particle F

Toner particle F were produced in the same manner as toner particle A, except that the addition quantity of resin fine particle A was changed to 10 g (0.5 parts by weight) and that silica A was used instead of silica B.

### (7) Preparation of Toner Particle G

Toner particle G were produced in the same manner as toner particle A, except that the addition quantity of resin fine particle C was changed to 10 g (0.5 parts by weight) and that silica A was used instead of silica B as resin fine particle.

### (8) Preparation of Toner Particle H

Toner particle H were produced in the same manner as toner particle A, except that 6 g (0.3 parts by weight) of resin fine particle A was added as resin fine particle.

### (9) Preparation of Toner Particle I

Toner particle I were produced in the same manner as toner particle A, except 6 g (0.3 parts by weight) of resin fine particle C was added and that silica A was used instead of silica B as resin fine particle.

### (10) Preparation of Toner Particle J

Toner particle J were produced in the same manner as toner particle A, except that no resin fine particle was added and that silica A was used instead of silica B.

TABLE 1

| | Fluororesin fine particles | | | | | |
|---|---|---|---|---|---|---|
| | | | | Addition | | Cover- |
| | | | Particle | quantity | | age |
| | | | diameter | (parts | | (A1) |
| | Kind | Resin | (nm) | by weight) | Silica | (%) |
| Toner | Resin fine | PFA | 0.11 | 1 | Silica B | 9.8 |
| particle A | particle A | | | | | |
| Toner | Resin fine | PFA | 0.11 | 0.5 | Silica B | 4.8 |
| particle B | particle A | | | | | |
| Toner | Resin fine | PFA | 0.32 | 1.5 | Silica B | 5.7 |
| particle C | particle B | | | | | |
| Toner | Resin fine | FEP | 0.12 | 1 | Silica B | 9.7 |
| particle D | particle C | | | | | |
| Toner | Resin fine | PTFE | 0.10 | 1 | Silica B | 11.1 |
| particle E | particle D | | | | | |
| Toner | Resin fine | PFA | 0.11 | 0.5 | Silica A | 4.8 |
| particle F | particle A | | | | | |
| Toner | Resin fine | FEP | 0.12 | 0.5 | Silica A | 5.9 |
| particle G | particle C | | | | | |
| Toner | Resin fine | PFA | 0.11 | 0.3 | Silica B | 3.7 |
| particle H | particle A | | | | | |
| Toner | Resin fine | FEP | 0.12 | 0.3 | Silica A | 3.5 |
| particle I | particle C | | | | | |
| Toner | — | — | — | 0 | Silica A | 0 |
| particle J | | | | | | |

### 5. Preparation of Carrier

### (1) Preparation of Carrier A

The preparation of carrier A was performed as follows.

Into a fluidized bed coating apparatus (produced by Freund Corporation, SFC-5), 10 kg (100 parts by weight) of ferrite having a diameter of 50 μm (produced by Powdertech Co., Ltd., F51-50), 0.06 kg (0.6 parts by weight) of resin fine particle A dissolved in 40 kg of toluene, and 2.94 kg of Epicoat 1004 (produced by Japan Epoxy Resins Co., Ltd.) were fed and then ferrite coating treatment was conducted under 80° C. hot air blowing. Subsequently, the resulting mixed lump of a covering resin and ferrite was baked at 230° C. for 1 hour in a drier and then cooled and pulverized to yield carrier A.

The fluorine compound coverage (A2) of the resulting carrier was measured.

A2 (%) was obtained from the following equation (2) where the fluorescent X-ray intensity of fluoride in the carrier surface measured with an fluorescent X-ray analyzer (RI×200, manufactured by Rigaku Corp.) was let be a2, and the fluorescent X-ray intensity of fluoride in the carrier surface measured in the same manner as above when the carrier surface was covered with only fluororesin fine particle was let be b2.

The fundamental constitutions of carriers A to G are shown in Table 2.

A2(%)=a2/b2×100 (2)

### (2) Preparation of Carrier B

Carrier B was prepared in the same manner as carrier A, except that the addition quantity of resin fine particle A was changed to 0.03 kg (0.3 parts by weight) and that the addition quantity of Epicoat 1004 was changed to 2.97 kg.

### (3) Preparation of Carrier C

Carrier C was prepared in the same manner as carrier A, except that 0.06 kg (0.6 parts by weight) of resin fine particle C was used as resin fine particle.

### (4) Preparation of Carrier D

Carrier D was prepared in the same manner as carrier A, except that 0.06 kg (0.6 parts by weight) of resin fine particle D was used as resin fine particle.

### (5) Preparation of Carrier E

Carrier E was prepared in the same manner as carrier A, except that the addition quantity of resin fine particle A was changed to 0.6 kg (6 parts by weight) and that the addition quantity of Epicoat 1004 was changed to 2.4 kg.

### (6) Preparation of Carrier F

Carrier F was prepared in the same manner as carrier A, except that the addition quantity of resin fine particle C was changed to 0.6 kg (6 parts by weight) and that the addition quantity of Epicoat 1004 was changed to 2.4 kg.

### (7) Preparation of Carrier G

Carrier G was prepared in the same manner as carrier A, except that no resin fine particle was added and that the addition quantity of Epicoat 1004 was changed to 3 kg.

TABLE 2

| | Fluororesin | | |
|---|---|---|---|
| | | Addition | |
| | | quantity | Coverage |
| | | (parts by | (A2) |
| | Kind | weight) | (%) |
| Carrier A | PFA | 0.6 | 2 |
| Carrier B | PFA | 0.3 | 1 |
| Carrier C | FEP | 0.6 | 2 |
| Carrier D | PTFE | 0.6 | 2 |
| Carrier E | PFA | 6.0 | 20 |
| Carrier F | FEP | 6.0 | 20 |
| Carrier G | — | 0 | 0 |

### Example 1

### 1. Preparation of Two-Component Developer

A two-component developer was obtained by charging 30 g of covered toner particle A and 300 g of carrier A into a ball mill, and then stirring them for 10 minutes.

### 2. Evaluation

### (1) Evaluation of Image Density

Using the resulting two-component developer, image formation was performed and then the image density was evaluated.

That is, the resulting two-component developer was installed to a color printer adopting the touchdown system (FS-C5016N, manufactured by KYOCERA MITA Corp.) conditioned for negatively charged toners, and then an image pattern in accordance with ISO 12647, which contained a solid image and a 25% half image, was printed. The image densities in the solid image and the 25% half image were respectively measured using a spectrophotometer (SpectroEye, manufactured by GretagMacbeth Co.).

Subsequently, after single-shot printing a predetermined character image having a printing rate of 2% on 50,000 sheets, an image pattern in accordance with ISO 12647 was printed again, and the image densities in the solid image and the 25% half image were respectively measured using a spectrophotometer (SpectroEye, manufactured by GretagMacbeth Co.).

The result of the measurement of the solid image density obtained after the 50,000-sheet single-shot printing was evaluated in accordance with the following criteria. The results are shown in Table 3.

Good: The solid image density after 50,000-sheet single-shot printing is a value of 1.2 or more.
Bad: The solid image density after 50,000-sheet single-shot printing is a value of below 1.2.

From the result of the measurement of the 25% half image density, an image density change (image density after 50,000-sheet printing−initial image density) was calculated, and evaluated in accordance with the following criteria. The results are shown in Table 3.

Good: The absolute value of the image density change in a 25% half image is a value of 0.1 or less.
Bad: The absolute value of the image density change in a 25% half image is a value of over 0.1.

### (2) Evaluation of Image Density Unevenness

Using a resulting two-component developer, image formation was performed and then the image density unevenness was evaluated.

That is, the two-component developer was installed in the aforesaid evaluation machine, and a predetermined character image having a printing rate of 2% was single-shot printed on 50,000 sheets.

Subsequently, a 600 dpi 25% half image was outputted in a size of A3, and image densities at 9 points in the image were respectively measured using a spectrophotometer (SpectroEye, manufactured by GretagMacbeth Co.).

Then, the difference between the maximum and the minimum among the image densities obtained at the 9 points was calculated. It was defined as the image density unevenness and was evaluated in accordance with the following criteria

The results are shown in Table 3.
Good: The image density difference is below of 0.1.
Bad: The image density differences is a value of 0.1 or more.

### (3) Evaluation of Toner Charge Quantity

When image formation was performed using an obtained two-component developer, the toner charge quantity in the toner layer formed on the developing roll was evaluated.

That is, the two-component developer was installed in the aforesaid evaluation machine, and a predetermined character image having a printing rate of 2% was single-shot printed on 50,000 sheets.

At the beginning and at the time of the completion of the 50,000-sheet single-shot printing, the charge quantity (μC/g) in toner particle in a 5 mm×50 mm region in the toner layer formed on the developing roll in the developing device was measured with a charge quantity analyzer (MODEL 210HS, manufactured by TREK JAPAN Inc.). A toner charge quantity change (toner charge quantity after 50,000-sheet printing−initial toner charge quantity) was calculated from the measurements.

The results are shown in Table 3.

### Example 2

In Example 2, a two-component developer was produced and evaluated in the same manner as Example 1, except that carrier B was used as a carrier. The results are shown in Table 3.

### Example 3

In Example 3, a two-component developer was produced and evaluated in the same manner as Example 1, except that toner particle B was used as a toner particle and that carrier A was used as a carrier. The results are shown in Table 3.

### Example 4

In Example 4, a two-component developer was produced and evaluated in the same manner as Example 1, except that toner particle C was used as a toner particle. The results are shown in Table 3.

### Example 5

In Example 5, a two-component developer was produced and evaluated in the same manner as Example 1, except for toner particle D was used as a toner particle and that carrier C was used as a carrier. The results are shown in Table 3.

### Example 6

In Example 6, a two-component developer was produced and evaluated in the same manner as Example 1, except that toner particle E was used as a toner particle and that carrier D was used as a carrier. The results are shown in Table 3.

### Comparative Example 1

In Comparative Example 1, a two-component developer was produced and evaluated in the same manner as Example 1, except that toner particle F was used as a toner particle and that carrier E was used as a carrier. The results are shown in Table 3.

### Comparative Example 2

In Comparative Example 2, a two-component developer was produced and evaluated in the same manner as Example 1, except that toner particle G was used as a toner particle and that carrier F was used as a carrier. The results are shown in Table 3.

### Comparative Example 3

In Comparative Example 3, a two-component developer was produced and evaluated in the same manner as Example 1, except that toner particle H was used as a toner particle. The results are shown in Table 3.

### Comparative Example 4

In Comparative Example 4, a two-component developer was produced and evaluated in the same manner as Example 1, except that toner particle I was used as a toner particle and that carrier C was used as a carrier. The results are shown in Table 3.

### Comparative Example 5

In Comparative Example 5, a two-component developer was produced and evaluated in the same manner as Example 1, except that toner particle H was used as a toner particle and that carrier G was used as a carrier. The results are shown in Table 3.

### Comparative Example 6

In Comparative Example 6, a two-component developer was produced and evaluated in the same manner as Example 1, except that toner particle J was used as a toner particle and that carrier E was used as a carrier. The results are shown in Table 3.

TABLE 3

| | | | | | | Evaluation | | | |
|---|---|---|---|---|---|---|---|---|---|
| | | | | | | Image density (−) | | | |
| | Developer | | | | | Solid image | | | |
| | Toner particle | | Carrier | | | | After | | |
| | | Coverage | | Coverage | Coverage | | 50,000- | | |
| | | (A1) | | (A2) | ratio | | sheet | | |
| | Kind | (%) | Kind | (%) | (A2/A1) | Initial | printing | Judgment | Change |
| Example 1 | Toner | 9.8 | Carrier A | 2.0 | 0.20 | 1.43 | 1.39 | Good | −0.04 |
| | particle A | | | | | | | | |
| Example 2 | Toner | 9.8 | Carrier B | 1.0 | 0.10 | 1.46 | 1.44 | Good | −0.02 |
| | particle A | | | | | | | | |
| Example 3 | Toner | 4.8 | Carrier A | 2.0 | 0.42 | 1.5 | 1.49 | Good | −0.01 |
| | particle B | | | | | | | | |
| Example 4 | Toner | 5.7 | Carrier A | 2.0 | 0.18 | 1.5 | 1.41 | Good | −0.09 |
| | particle C | | | | | | | | |
| Example 5 | Toner | 9.7 | Carrier C | 2.0 | 0.21 | 1.47 | 1.34 | Good | −0.13 |
| | particle D | | | | | | | | |
| Example 6 | Toner | 11.1 | Carrier D | 2.0 | 0.18 | 1.42 | 1.32 | Good | −0.1 |
| | particle E | | | | | | | | |
| Comparative | Toner | 4.8 | Carrier E | 20.0 | 4.17 | 1.5 | 1.63 | Good | 0.13 |
| Example 1 | particle F | | | | | | | | |
| Comparative | Toner | 5.9 | Carrier F | 20.0 | 3.39 | 1.51 | 1.65 | Good | 0.14 |
| Example 2 | particle G | | | | | | | | |
| Comparative | Toner | 3.7 | Carrier A | 2.0 | 0.54 | 1.48 | 1.64 | Good | 0.16 |
| Example 3 | particle H | | | | | | | | |
| Comparative | Toner | 3.5 | Carrier C | 2.0 | 0.57 | 1.54 | 1.61 | Good | 0.07 |
| Example 4 | particle I | | | | | | | | |
| Comparative | Toner | 3.7 | Carrier G | 0 | 0 | 1.29 | 1.01 | Bad | −0.28 |
| Example 5 | particle H | | | | | | | | |
| Comparative | Toner | 0 | Carrier E | 20.0 | — | 1.34 | 1.03 | Bad | −0.31 |
| Example 6 | particle J | | | | | | | | |

| | Evaluation | | | | | | | |
|---|---|---|---|---|---|---|---|---|
| | | | | | Image | | | |
| | | | | | density | Toner charge | | |
| | | | | | unevenness | quantity | | |
| | Image density (−) | | | | 25% Half | (μc/g) | | |
| | 25% Half image | | | | image | Character image | | |
| | | After | | | After | | After | |
| | | 50,000- | | | 50,000- | | 50,000- | |
| | | sheet | | | sheet | | sheet | |
| | Initial | printing | Change | Judgment | printing | Initial | printing | Change |
| Example 1 | 0.56 | 0.51 | −0.05 | Good | Good | −14.9 | −16.5 | −1.6 |
| Example 2 | 0.52 | 0.53 | 0.01 | Good | Good | −15.8 | −17.7 | −1.9 |
| Example 3 | 0.6 | 0.6 | 0 | Good | Good | −12.3 | −13 | −0.7 |
| Example 4 | 0.54 | 0.53 | −0.01 | Good | Good | −13.2 | −15.1 | −1.9 |
| Example 5 | 0.53 | 0.51 | −0.02 | Good | Good | −13.7 | −17 | −3.3 |
| Example 6 | 0.5 | 0.5 | 0 | Good | Good | −16.4 | −20.2 | −3.8 |
| Comparative | 0.53 | 0.69 | 0.16 | Bad | Good | 15 | 10.8 | −4.2 |
| Example 1 | | | | | | | | |
| Comparative | 0.56 | 0.72 | 0.16 | Bad | Good | 14.7 | 11.7 | −3 |
| Example 2 | | | | | | | | |
| Comparative | 0.54 | 0.73 | 0.19 | Bad | Good | −12.5 | −7.9 | 4.6 |
| Example 3 | | | | | | | | |
| Comparative | 0.54 | 0.69 | 0.15 | Bad | Good | −13.1 | −8.3 | 4.8 |
| Example 4 | | | | | | | | |
| Comparative | 0.43 | 0.15 | −0.28 | Bad | Bad | −23.5 | −30.2 | −6.7 |
| Example 5 | | | | | | | | |
| Comparative | 0.39 | 0.19 | −0.2 | Bad | Bad | 19.8 | 27.5 | 7.7 |
| Example 6 | | | | | | | | |

According to the two-component developer of the present invention, by covering the surface of a toner particle with a fluorine compound and also covering the surface of a carrier with the fluorine compound and by adjusting the ratio of the coverage on the toner surface (A1) and the coverage on the carrier surface (A2) to within a predetermined range, it has become possible to control the non-electrostatic adhesion force of toner particle with a carrier, etc. and also to effectively maintain the charging property of the toner particle.

As a result, it has become possible to maintain the image density in formed images stably even when image formation is performed continuously for a long time.

Therefore, the two-component developer and the image forming device of the present invention are expected to contribute particularly to prevention of image property degradation with time in various image forming devices such as high-speed color copying machines and color printers.

What is claimed is:

1. A two-component developer in which the surface of a toner particle and the surface of a carrier are each covered with a fluorine compound,
wherein a ratio represented by A2/A1 is adjusted to a value within a range of from 0.1 to 0.5 where A1 is a coverage with the fluorine compound on the surface of the toner particle and A2 is a coverage with the fluorine compound on the surface of the carrier.

2. The two-component developer according to claim 1, wherein the fluorine compound is at least one kind of fluororesin selected from the group consisting of a polytetrafluoroethylene polymer (PTFE), a tetrafluoroethylene-hexafluoropropylene copolymer (FEP), a tetrafluoroethylene-perfluoro(alkyl vinyl ether) copolymer (PFA), and an ethylene-tetrafluoroethylene copolymer (ETFE).

3. The two-component developer according to claim 1, wherein the coverage (A1) with the fluorine compound on the surface of the toner particle is adjusted to a value within the range of from 4 to 14%.

4. The two-component developer according to claim 1, wherein the coverage (A2) with the fluorine compound on the surface of the carrier is adjusted to a value within the range of from 0.5 to 4%.

5. The two-component developer according to claim 1, wherein the fluorine compound covering the toner particle comprises fluororesin fine particle which is fixed to the surface of the toner particle.

6. The two-component developer according to claim 5, wherein the fluorine compound covering the toner particle is obtained by stirring a toner raw powder, the fluororesin fine particle, and inorganic fine particle together.

7. The two-component developer according to claim 1, wherein the fluorine compound covering the carrier comprises a thermosetting resin and fluororesin fine particle.

8. The two-component developer according to claim 1, wherein that is to be used for touchdown development using a developing roll arranged in opposition to an electrostatic latent image support and a magnetic roll which forms a magnetic brush composed of toner particle and a carrier and which is arranged in opposition to the developing roll, and that is to be used for touchdown development where a first DC bias and an AC bias are supply to the developing roll and a second DC bias is supplied to the magnetic roll and a toner layer is formed on the developing roll due to the potential difference between the first DC bias and the second DC bias and due to the AC bias, and thereby a latent image is developed on the electrostatic latent image support.

9. The two-component developer according to claim 1, wherein the developer is a negatively charged two-component developer.

10. An image forming device comprising a developing device that has a developing roll arranged in opposition to an electrostatic latent image support and a magnetic roll which forms a magnetic brush composed of toner particle and a carrier which constitute the two-component developer and which is arranged in opposition to the developing roll, and that adopts a touchdown developing system where a first DC bias and an AC bias are supply to the developing roll and a second DC bias is supplied to the magnetic roll and a toner layer is formed on the developing roll due to the potential difference between the first DC bias and the second DC bias and due to the AC bias, and thereby a latent image is developed on the electrostatic latent image support, wherein the surfaces of the toner particle and the carrier which constitute the two-component developer are each covered with a fluorine compound, and a ratio represented by A2/A1 is adjusted to a value within the range of from 0.1 to 0.5 where the coverage with the fluorine compound on the surface of the toner particle is let be A1 and the coverage with the fluorine compound on the surface of the carrier is let be A2.
